(19) United States
(12) Patent Application Publication
(10) Pub. No.: US 2016/0017755 A1
(43) Pub. Date: Jan. 21, 2016

(54) COMMON JOINT FOR A COMBUSTOR, DIFFUSER, AND TOBI OF A GAS TURBINE ENGINE

(71) Applicant: UNITED TECHNOLOGIES CORPORATION, Hartford, CT (US)

(72) Inventor: Kevin Joseph Low, Portland, CT (US)

(21) Appl. No.: 14/759,700

(22) PCT Filed: Jan. 29, 2013
(86) PCT No.: PCT/US13/23641

§ 371 Date: Jul. 8, 2015

(51) Int. Cl. F01D 25/28; F01N 3/20; F01D 25/24; F02C 3/04

(52) U.S. Cl. CPC F01D 25/28; F02C 3/04; F01N 3/20; F01D 25/24; F05D 2240/35; F05D 2240/90; F05D 2220/32

(57) ABSTRACT

An assembly for a gas turbine engine is disclosed. The gas turbine engine may have a combustor, a diffuser, and a tangential onboard injector. The assembly may include a common joint between the combustor, the diffuser, and the tangential onboard injector.

### CROSS-REFERENCE TO RELATED APPLICATION

This patent application is a US National Stage under 35 U.S.C. §371, claiming priority to International Application No. PCT/US13/023641 filed on Jan. 29, 2013.

### FIELD OF THE DISCLOSURE

The present disclosure relates generally to gas turbine engines and, more particularly, to connections within a gas turbine engine.

### BACKGROUND OF THE DISCLOSURE

Gas turbine engines typically include a compressor, a combustor, and a turbine, with an annular flow path extending axially through each. Initially, air flows through the compressor where it is compressed or pressurized. The combustor then mixes and ignites the compressed air with fuel, generating hot combustion gases. These hot combustion gases are then directed from the combustor to the turbine where power is extracted from the hot gases by causing blades of the turbine to rotate.

Typically, air from the compressor passes through a diffuser, where the air stream is split into multiple flow paths. A central flow path through the combustion chamber of a combustor provides for the combustion of fuel within the combustion chamber, while flow paths radially inner and outer to the combustion chamber provide cooling air to the combustor and other parts of the gas turbine engine. A tangential onboard injector (TOBI), which is a well known device, receives the cooling air and passes it through nozzles that discharge the cooling air tangentially to the rotating turbine. In this way, the TOBI cools the disks and blades of the turbine in a gas turbine engine.

In prior designs, the combustor was mounted by way of a support structure bolted to the TOBI. In a separate connection, the TOBI was also bolted to the case of the diffuser for location of the TOBI and diffuser within the gas turbine engine. However, it is desirable that the gas turbine engine be as simple and made of as few parts as possible. Accordingly, there exists a need for an improved and cost-effective gas turbine engine assembly.

### SUMMARY OF THE DISCLOSURE

According to one embodiment of the present disclosure, an assembly for a gas turbine engine is disclosed. The assembly may comprise a combustor, a diffuser surrounding the combustor, a tangential onboard injector downstream of the diffuser, and a common joint joining the combustor, the diffuser, and the tangential onboard injector.

In a refinement, the joint may couple a flange of the tangential onboard injector to a combustor flange of the combustor. The joint may further couple the flange of the tangential onboard injector and the combustor flange to a flange of the diffuser.

In a related refinement, the combustor flange may extend from a structural support of the combustor. The structural support may have openings and may extend from the combustor flange to an inner liner of the combustor.

In a related refinement, a size of the openings may be determined by a desired amount of flow into the tangential onboard injector.

In a related refinement, the joint and the structural support may provide mounting support for the combustor.

In another related refinement, the structural support may provide flexibility for an interference fit between the combustor and a turbine of the gas turbine engine.

In a related refinement, the structural support may provide for tolerance differences between the combustor and the turbine.

In another refinement, the joint may include a lip to radially locate at least one of the combustor, diffuser, and tangential onboard injector.

In another refinement, the common joint may assist in locating the tangential onboard injector, combustor, and diffuser within the gas turbine engine.

In yet another refinement, the combustor, diffuser, and tangential onboard injector may be coupled together at the joint by a plurality of nuts and bolts, and the plurality of nuts and bolts may hold the combustor, diffuser, and tangential onboard injector in position.

According to another embodiment, a gas turbine engine is disclosed. The gas turbine engine may comprise a compressor, a combustor downstream of the compressor, a turbine downstream of the combustor, a diffuser surrounding the combustor, a tangential onboard injector downstream of the combustor, and a single joint coupling the combustor, the diffuser, and the tangential onboard injector.

In a refinement, the single joint may couple a flange of the tangential onboard injector to a structural support of the combustor and to a case of the diffuser.

In a related refinement, the diffuser case may include a diffuser flange and the combustor structural support may include a combustor flange. The combustor flange may fit in-between the diffuser flange and the flange of the tangential onboard injector.

In a related refinement, the structural support of the combustor may support the combustor within the gas turbine engine. The structural support may comprise a wall extending from the combustor flange to an inner liner of the combustor. The wall may have a plurality of openings defining a flow passage to an inlet of the tangential onboard injector. A size of the openings may be determined by a desired amount of flow into the tangential onboard injector.

In a related refinement, the structural support may provide flexibility for an interference fit between the combustor and the turbine.

In another related refinement, the single joint may assist in locating the combustor, diffuser, and tangential onboard injector within the gas turbine engine.

According to yet another embodiment, an assembly for a gas turbine engine is disclosed. The gas turbine engine may have a combustor, a diffuser surrounding the combustor, and a tangential onboard injector. The assembly may comprise at least one common joint between the combustor, the diffuser, and the tangential onboard injector.

In a refinement, the at least one common joint may couple a flange of the diffuser to a flange of the combustor to a flange of the tangential onboard injector.

In a related refinement, the assembly may further comprise a plurality of fasteners for assembling the at least one common joint together.

In another related refinement, the at least one common joint may assist in locating the combustor, diffuser, and tangential onboard injector within the gas turbine engine.

These and other aspects and features of the disclosure will become more readily apparent upon reading the following detailed description when taken in conjunction with the accompanying drawings. Although various features are disclosed in relation to specific exemplary embodiments of the invention, it is understood that the various features may be combined with each other, or used alone, with any of the various exemplary embodiments of the invention without departing from the scope of the invention.

### BRIEF DESCRIPTION OF THE DRAWINGS

FIG. 1 is a cross-sectional view of a gas turbine engine according to one embodiment of the present disclosure;

FIG. 2 is a cross-sectional view of part of a combustor, a diffuser, and a TOBI of the gas turbine engine of FIG. 1;

FIG. 3 is a perspective cut-away view of part of the combustor of FIG. 2;

FIG. 4 is an enlarged cross-sectional view of part of the gas turbine engine of FIG. 2 showing a common combustor/diffuser/TOBI connection according to the present disclosure; and

FIG. 5 is a flowchart outlining a method for constructing a gas turbine engine according to an embodiment of the present disclosure.

While the present disclosure is susceptible to various modifications and alternative constructions, certain illustrative embodiments thereof, will be shown and described below in detail. It should be understood, however, that there is no intention to be limited to the specific embodiments disclosed, but on the contrary, the intention is to cover all modifications, alternative constructions, and equivalents along within the spirit and scope of the present disclosure.

### DETAILED DESCRIPTION

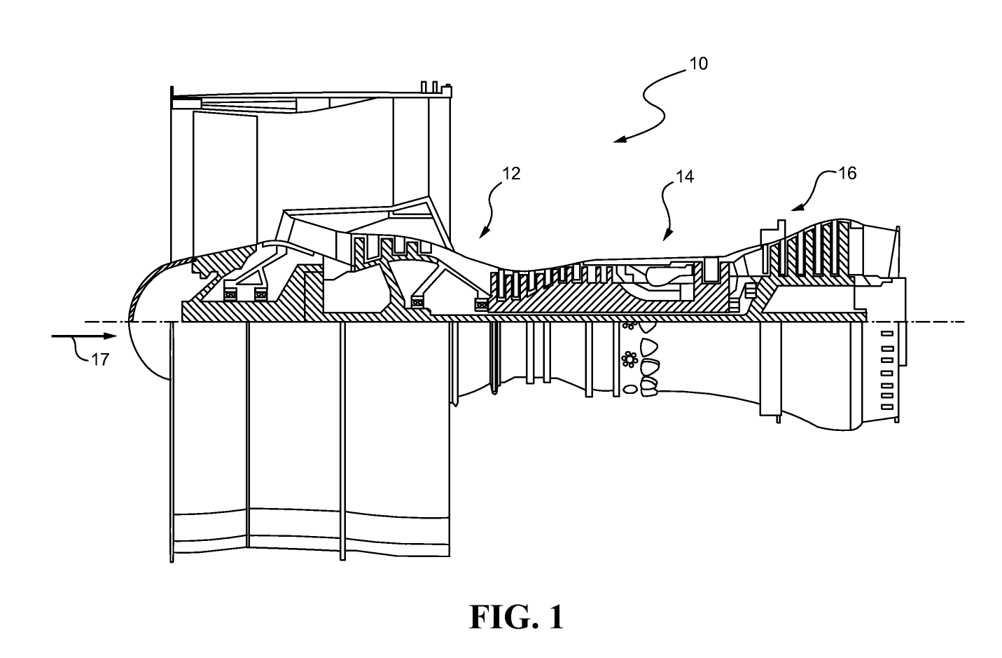

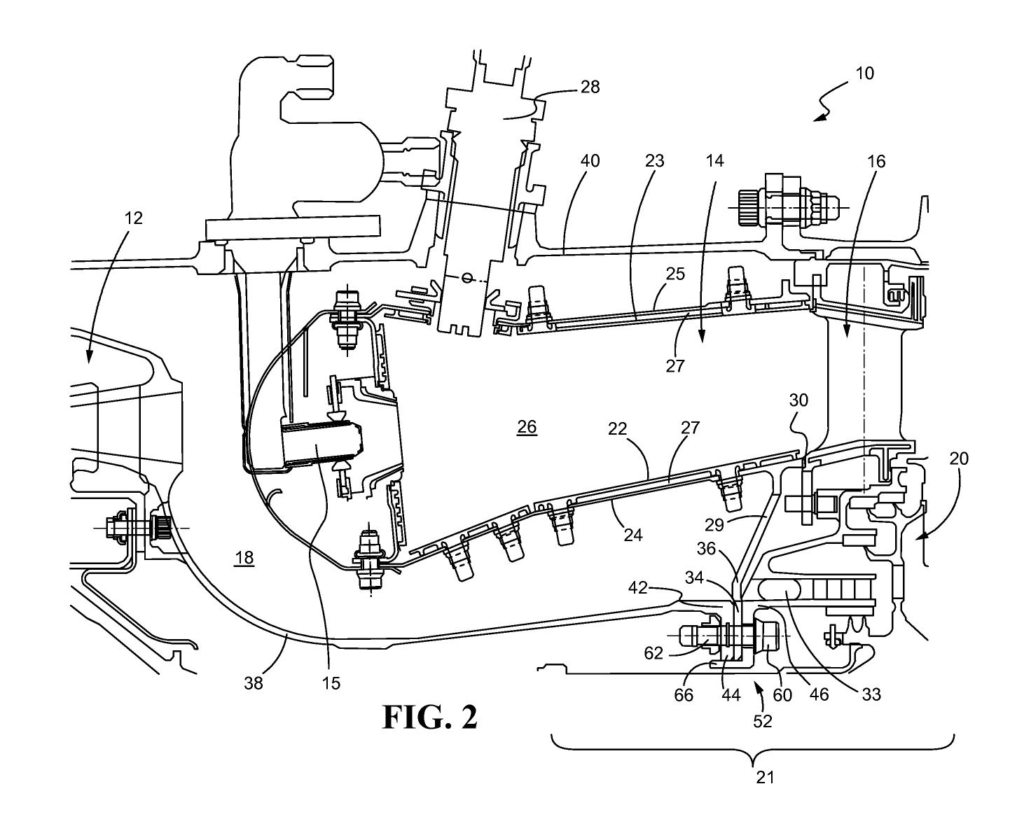

Referring now to the drawings, and with specific reference to FIG. 1, in accordance with the teachings of the disclosure, an exemplary gas turbine engine 10 is shown. The gas turbine engine 10 may generally comprise a compressor 12 where air is pressurized, a combustor 14 downstream of the compressor which mixes and ignites the compressed air with fuel from a fuel injector 15 (FIG. 2) and thereby generates hot combustion gases, a turbine 16 downstream of the combustor 14 for extracting power from the hot combustion gases, and an annular flow path 17 extending axially through each. It will be understood that the common combustor/diffuser/TOBI connection as disclosed later herein is not limited to the depicted embodiment of the gas turbine engine 10 but may be applicable to other types of gas turbine engines as well.

Referring now to FIG. 2, an exemplary cross-sectional view of part of the combustor 14, a diffuser 18, and a TOBI (tangential onboard injector) 20 of the gas turbine engine 10, generally referred to herein as an assembly 21, is shown. The combustor 14 may comprise an inner liner 22 and an outer liner 23, which define a combustion chamber 26. An inner combustor shell 24 and an outer combustor shell 25 surround the liners 22, 23 and thereby define an air flow passage 27 therebetween. An igniter 28 may be provided through the outer combustor shell 25 and outer liner 23 to ignite the fuel and air mixture in the combustor chamber 26.

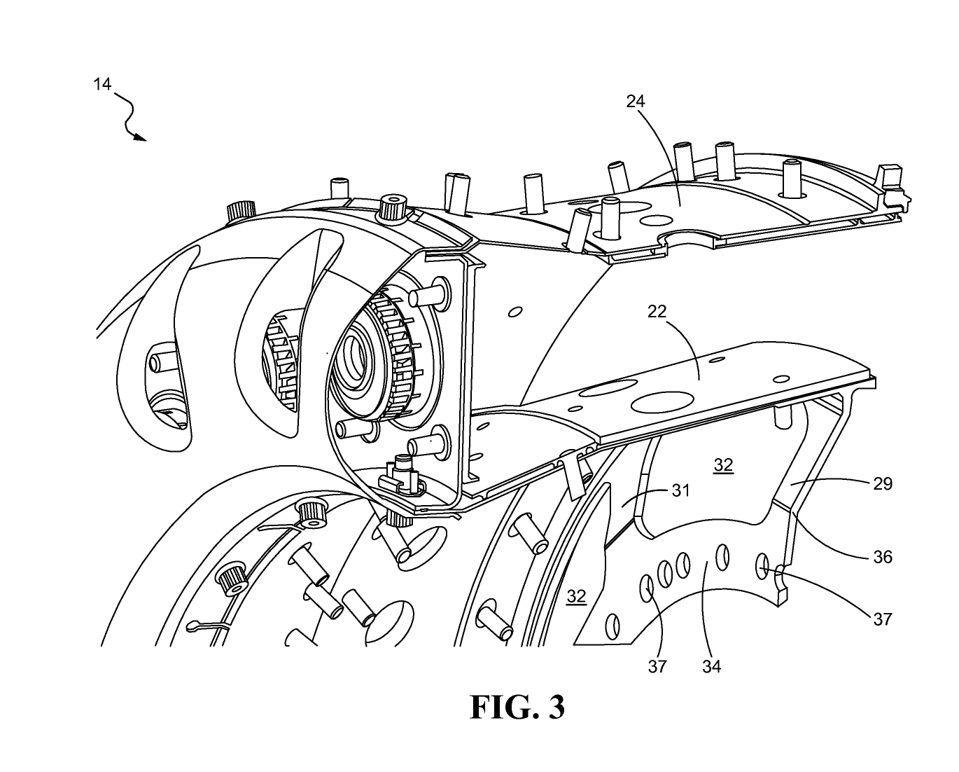

Extending from a downstream location on the inner liner 22 may be a structural support 29 of the combustor 14 for mounting the combustor 14 within the gas turbine engine 10 and supporting an interference fit (referred to by the numeral 30 in FIG. 2) between the combustor 14 and the turbine 16. As shown best in FIG. 3, the structural support 29 may comprise a generally annular wall 31 having a plurality of windows or openings 32. A combustor flange 34 may comprise an annular ring at a radially inner end 36 of the annular wall 31. The combustor flange 34 may be adapted for mounting and coupling the structural support 29. For example, the combustor flange 34 may have a plurality of holes 37 for receiving bolts, or other suitable means of attachment.

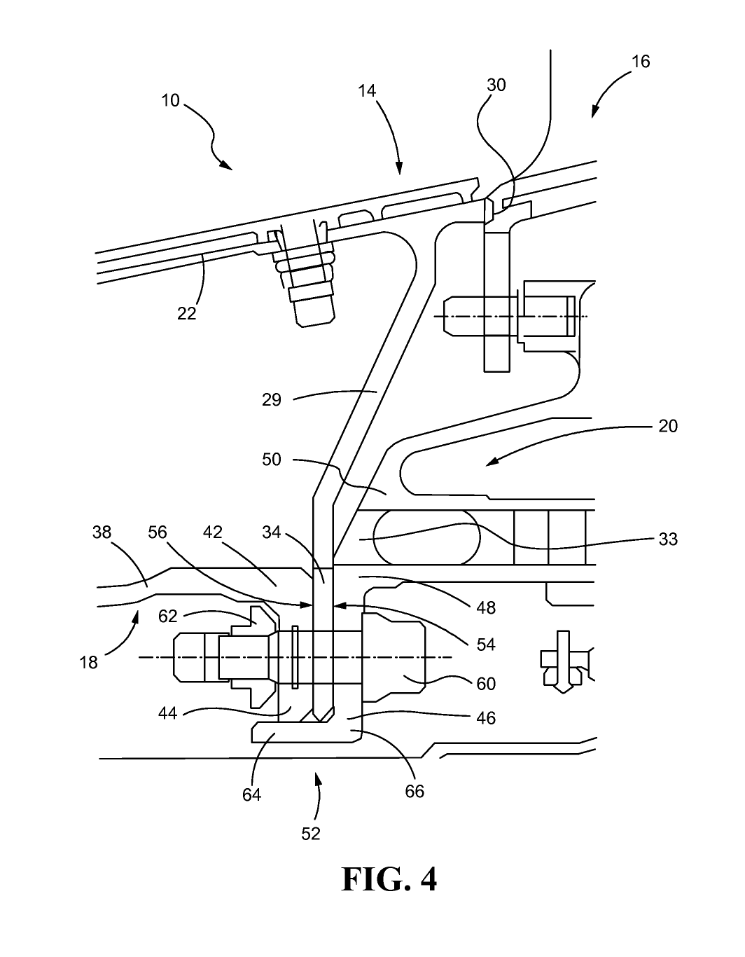

Referring back to FIG. 2, the diffuser 18 may comprise an inner case 38 and an outer case 40. A downstream end 42 of the inner case 38 may include a flange 44, comprised of an annular ring, extending radially inward from the end 42 of the inner case 38. The flange 44 may be adapted for mounting and coupling the inner case 38, such as by way of holes for receiving bolts or other suitable means of attachment. The diffuser 18 may diffuse the air flow coming out of the compressor 12. The inner case 38 and the inner liner 22 of the combustor 14 may define a flow path, directing part of the air flow from the compressor 12 through the openings 32 of the combustor structural support 29 and into the TOBI 20. The openings 32 may create a flow passage to an inlet 33 of the TOBI 20. Once the air flow passes through the openings 32 and into the inlet 33, the TOBI 20 receives and injects the cooling air to the turbine 16 for cooling of the turbine disks, blades, and vanes. As shown best in FIG. 4, the TOBI 20 may include a flange 46, comprised of a generally annular ring, extending radially inward from an end 48 of a wall 50 of the TOBI 20. The flange 46 may be adapted for mounting and coupling the TOBI, such as by way of holes for receiving bolts or other means of attachment.

The combustor 14, the diffuser 18, and the TOBI 20 are coupled together at a single, common joint 52, joining together the combustor flange 34, the diffuser flange 44, and the TOBI flange 46. In sharp contrast to prior art designs requiring multiple, separate joints, the single, common joint 52 may couple the TOBI 20 to the combustor 14 and may further couple the TOBI 20 and combustor 14 to the diffuser 18. In particular, the TOBI flange 46 may abut a downstream surface 54 of the combustor flange 34, while the diffuser flange 44 may abut an upstream surface 56 of the combustor flange 34. The combustor flange 34 may be sandwiched or fit in-between the diffuser flange 44 and the TOBI flange 46, thereby providing mounting support to the structural support 29. In addition, the joint 52 may assist in locating the combustor 14, diffuser 18, and TOBI 20 within the gas turbine engine 10.

A plurality of bolts 60 may be received through the holes in the TOBI flange 46, combustor flange 34, and diffuser flange 44, while a plurality of nuts 62 may be secured to the bolts 60 to assemble the joint 52 together and hold the combustor flange 34, diffuser flange 44, and TOBI flange 46 in position, thereby assisting in the location of the combustor 14, diffuser 18, and TOBI 20 within the gas turbine engine 10. Other means of attachment are certainly possible.

In addition, the TOBI flange 46 may have a lip 64 projecting axially upstream from a radially inner end 66 of the TOBI flange 46. The lip 64 may radially locate the combustor flange 34, diffuser flange 44 and the inner case 38 of the diffuser 18. Although shown and described as extending from the TOBI flange 46, it is to be understood that the lip 64 may also extend from the combustor flange 34 or diffuser flange 44 to radially locate the TOBI flange 46, combustor flange 34, and/or diffuser flange 44.

Another benefit of joining the TOBI flange 46 and combustor flange 34 to the diffuser flange 44 all in one common joint 52 is that the annular wall 30 of the combustor structural support 29 may be long and flexible. Prior designs supplied the gas turbine engine with two separate joints, specifically, one joint between the TOBI and the case, and another separate joint between the TOBI and the combustor structural support. While somewhat effective for a given application, it provided the combustor structural support with a shorter and stiffer annular wall due to the space required for the second separate joint. With the single joint between the combustor 14, diffuser 18, and TOBI 20 of the present disclosure, on the other hand, the uninterrupted and longer length of the annular wall 30 from the combustor flange 34 to the inner liner 22 can provide flexibility for the interference fit between the combustor 14 and turbine 16, thereby providing for tolerance differences between the combustor 14 and turbine 16.

Moreover, the placement of the joint 52, along with the uninterrupted and longer length for the annular wall 30, provides for flexibility in the size of the windows or openings 32 because the longer length of the annular wall 30 can allow larger openings 32. This may be beneficial when considering the flow path through the openings 32 and into the TOBI 20. The size of the openings 32 may be determined by a desired amount of flow into the TOBI 20. For example, if more air flow is desired into the inlet 33 of the TOBI 20, the openings 32 can be made larger. In addition to the length of the annular wall 30 and size of the openings 32, the width, thickness, material composition, and quantity of openings 32 in the annular wall 30 may also contribute to providing structural support and flexibility.

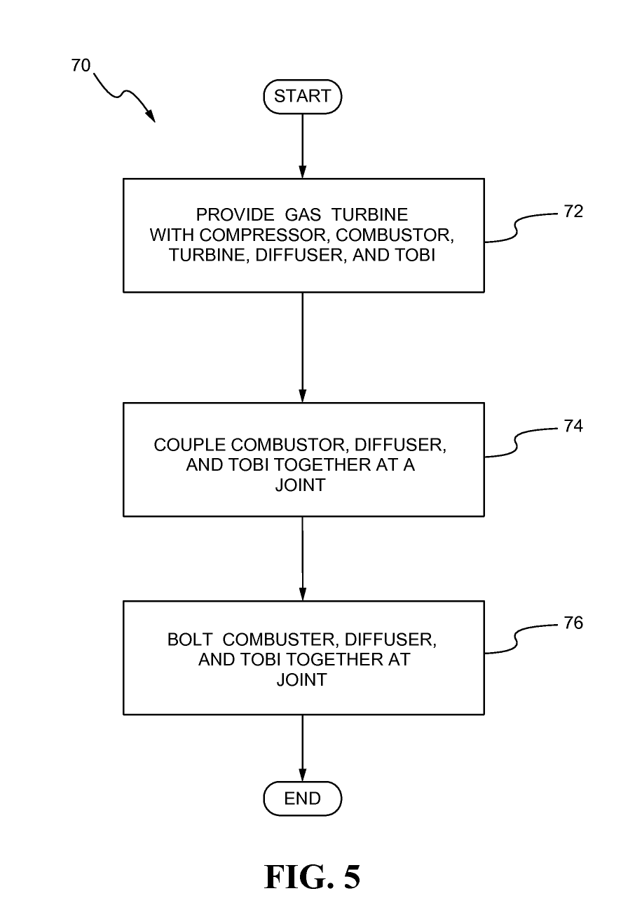

Turning now to FIG. 5, a flowchart outlining a method 70 for constructing the gas turbine engine 10 is shown, according to another exemplary embodiment of the present disclosure. At a first step 72, the gas turbine engine 10 is provided with the compressor 12, the combustor 14, the turbine 16, the diffuser 18, and the TOBI 20. A second step 74 of the method 70 may be coupling the combustor 14, diffuser 18, and TOBI 20 together at the single, common joint 52. At a final step 76, the combustor 14, diffuser 18, and TOBI 20 are bolted together at a joint 52 by a plurality of nuts 62 and bolts 60. The method 70 may further comprise fitting in the combustor flange 34 between the diffuser flange 44 and the TOBI flange 46 at the common joint 52. The method 70 may further include assisting the location of the combustor 14, the diffuser 18, and the TOBI 20 within the gas turbine engine 10 using the joint 52.

It is to be understood that other components, in addition to the combustor 14, diffuser 18, and TOBI 20, may be joined to joint 52 without departing from the teachings of this disclosure. For example, a dirt deflector may be coupled at the joint 52, such as on either side of the combustor flange 34, in order to prevent particulate matter from entering the TOBI 20. Other components and arrangements are certainly possible.

### INDUSTRIAL APPLICABILITY

From the foregoing, it can be seen that the teachings of this disclosure can find industrial application in any number of different situations, including but not limited to, gas turbine engines. Such engines may be used, for example, on aircraft for generating thrust, or in land, marine, or aircraft applications for generating power.

The disclosure described provides an improved and cost-effective assembly for gas turbine engines. By providing a single, common joint between the combustor, diffuser, and TOBI, these three parts are secured within the gas turbine engine to each other in an efficient manner. By connecting the three parts together at a common joint, the present invention eliminates the need for two separate joints between the parts, resulting in a reduced part count, and thereby lowering the costs associated with labor and manufacture. In addition, the common joint between the combustor, diffuser, and TOBI leads to more flexibility in design for the combustor support structure. Due to the elimination of a separate joint between the combustor and the TOBI, the combustor support structure may have a greater length, making it more flexible to withstand tolerance differences between the combustor and the turbine, while still maintaining an interference fit between the combustor and turbine. Furthermore, by eliminating the need for a separate joint between the combustor and the TOBI, the location of the joint and the length of the combustor support structure make it optimal for tailoring the size of the windows through which air flows into the TOBI.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

What is claimed is:

1. An assembly for a gas turbine engine, comprising:
a combustor;
a diffuser surrounding the combustor;
a tangential onboard injector downstream of the diffuser; and
a common joint joining the combustor, the diffuser, and the tangential onboard injector.

2. The assembly of claim 1, wherein the joint couples a flange of the tangential onboard injector to a combustor flange of the combustor, and wherein the joint further couples the flange of the tangential onboard injector and the combustor flange to a flange of the diffuser.

3. The assembly of claim 2, wherein the combustor flange extends from a structural support of the combustor, the structural support having openings and extending from the combustor flange to an inner liner of the combustor.

4. The assembly of claim 3, wherein a size of the openings is determined by a desired amount of flow into the tangential onboard injector.

5. The assembly of claim 3, wherein the joint and the structural support provide mounting support for the combustor.

6. The assembly of claim 3, wherein the structural support provides flexibility for an interference fit between the combustor and a turbine of the gas turbine engine.

7. The assembly of claim 3, wherein the structural support provides for tolerance differences between the combustor and the turbine.

8. The assembly of claim 1, wherein the joint includes a lip to radially locate at least one of the combustor, the diffuser, and tangential onboard injector.

9. The assembly of claim 1, wherein the common joint assists in locating the tangential onboard injector, combustor, and diffuser within the gas turbine engine.

10. The assembly of claim 1, wherein the combustor, diffuser, and tangential onboard injector are coupled together at the joint by a plurality of nuts and bolts, and wherein the plurality of nuts and bolts hold the combustor, diffuser, and tangential onboard injector in position.

11. A gas turbine engine, comprising:
a compressor;
a combustor downstream of the compressor;
a turbine downstream of the combustor;
a diffuser surrounding the combustor;
a tangential onboard injector downstream of the combustor; and
a single joint coupling the combustor, the diffuser, and the tangential onboard injector.

12. The gas turbine engine of claim 11, wherein the single joint couples a flange of the tangential onboard injector to a structural support of the combustor and to a case of the diffuser.

13. The gas turbine engine of claim 12, wherein the diffuser case includes a diffuser flange and the combustor structural support includes a combustor flange, and wherein the combustor flange is fit in-between the diffuser flange and the flange of the tangential onboard injector.

14. The gas turbine engine of claim 13, wherein the structural support of the combustor supports the combustor within the gas turbine engine, the structural support comprising a wall extending from the combustor flange to an inner liner of the combustor, the wall having a plurality of openings defining a flow passage to an inlet of the tangential onboard injector, and wherein a size of the openings is determined by a desired amount of flow into the tangential onboard injector.

15. The gas turbine engine of claim 14, wherein the structural support provides flexibility for an interference fit between the combustor and the turbine.

16. The gas turbine engine of claim 13, wherein the single joint assists in locating the combustor, diffuser, and tangential onboard injector within the gas turbine engine.

17. An assembly for a gas turbine engine having a combustor, a diffuser surrounding the combustor, and a tangential onboard injector, the assembly comprising:
at least one common joint between the combustor, the diffuser, and the tangential onboard injector.

18. The assembly of claim 17, wherein the at least one common joint couples a flange of the diffuser to a flange of the combustor to a flange of the tangential onboard injector.

19. The assembly of claim 18, further comprising a plurality of fasteners for assembling the at least one common joint together.

20. The assembly of claim 19, wherein the at least one common joint assists in locating the combustor, diffuser, and tangential onboard injector within the gas turbine engine.
